(19) United States
(12) Patent Application Publication
(10) Pub. No.: US 2003/0137496 A1
(43) Pub. Date: Jul. 24, 2003

(54) Systems and methods for facilitating interaction with a whiteboard

(76) Inventors: Chad Stevens, Boise, ID (US); Barbara Gaston, Garden City, ID (US)

Correspondence Address: HEWLETT-PACKARD COMPANY, Intellectual Property Administration, P.O. Box 272400, Fort Collins, CO, 80527-2400, US

(21) Appl. No.: 10/055,313

(22) Filed: Jan. 23, 2002

(51) Int. Cl. G09G 5/00

(52) U.S. Cl. 345/173

(57) ABSTRACT

A whiteboard apparatus is provided. Briefly described, one such whiteboard apparatus comprises an electronic paper display device and a writing surface. The electronic paper display device is configured to display an image. The writing surface is arranged in superimposed relationship with the electronic paper display device. The present invention may also be viewed as method. Briefly, one such method comprises the steps of: providing an electronic paper display device configured to display an image on a whiteboard; arranging a writing surface in superimposed relationship with the electronic paper display device; and displaying an image on the electronic paper display device over which a user may write on the writing surface.

### TECHNICAL FIELD

The present invention is generally related to whiteboards and, more particularly, is related to systems and methods for facilitating interaction with a whiteboard.

### BACKGROUND OF THE INVENTION

Whiteboards are a well-known medium used to facilitate personal thoughts and group discussions by providing a convenient surface upon which notes, drawings, charts, and other annotations may be made. As with the traditional chalkboard, whiteboards allow annotations to be made in multiple colors and then erased. However, whiteboards offer several advantages over chalkboards, including a clean white surface which provides for greater contrast over the traditional green background of chalkboards. In addition, writing on a whiteboard is easier for many than on the traditional chalkboard. For example, the smooth writing surface of the whiteboard allows easy use of the erasable felt tip markers whereas the chalkboard surface provides a somewhat rough textured surface to hold chalk which is used for writing on such surfaces. In addition, many users prefer a whiteboard to a chalkboard simply because the marker may be gripped more comfortably than chalk and does not leave residue on the user's hand when gripped.

In recent years, whiteboards have been developed to allow the writings and annotations entered upon the whiteboard to be transmitted to a digital computer for storage, display and manipulation. Typically, these “electronic whiteboards” allow the writings and annotations made upon the whiteboard surface to be digitally-captured and saved in a personal computer to be displayed, transmitted or manipulated. Some electronic whiteboards also integrate with an optical scanner and/or printer to enable users to scan a document into the computer, display the document on the whiteboard, mark on the whiteboard surface, and scan and/or print the combined result. However, these electronic whiteboards typically require very advanced and expensive hardware and/or software to perform these functions. For example, some such devices employ a projector, optical scanner, personal computer, and a means for digitizing user input on the writing surface. Other electronic whiteboards, such as the Liveboard®, developed by Xerox, Inc. and currently manufactured and sold by Simply.com, Inc. (see http://www.wearesimply.com/), may employ expensive pen-based, interactive displays integrated with a personal computer. Thus, electronic whiteboards are typically very expensive, which may explain their relatively limited use today.

Thus, there is a need in the industry for an improved cost effective whiteboard.

### SUMMARY OF THE INVENTION

One embodiment of the present invention is a whiteboard apparatus. Briefly described, one such whiteboard apparatus comprises an electronic paper display device and a writing surface. The electronic paper display device is configured to display an image. The writing surface is arranged in superimposed relationship with the electronic paper display device.

The present invention may also be viewed as a method. Briefly, one such method comprises the steps of: providing an electronic paper display device configured to display an image on a whiteboard; arranging a writing surface in superimposed relationship with the electronic paper display device; and displaying an image on the electronic paper display device over which a user may write on the writing surface.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. Components in the drawings are not necessarily to scale, emphasis instead being placed upon clearly illustrating the principles of the present invention. Moreover, in the drawings, like reference numerals designate corresponding parts throughout the several views.

FIG. 1 is front perspective view of an embodiment of a whiteboard apparatus according to the present invention.

FIG. 2 is a side perspective view of the whiteboard apparatus of FIG. 1.

FIG. 3 is a block diagram of the whiteboard apparatus of FIGS. 1 and 2.

FIG. 4 is a front perspective view of the whiteboard apparatus of FIGS. 1 and 2 in which the electronic paper display device is displaying an embodiment of a reference image.

FIG. 5 is a front perspective view of the whiteboard apparatus of FIG. 4 in which a user has written on the writing surface over the reference image.

FIG. 6 is a front perspective view of the whiteboard apparatus of FIGS. 1 and 2 in which the electronic paper display device is displaying another embodiment of a reference image.

FIG. 7 is a front perspective view of the whiteboard apparatus of FIG. 6 in which a user has written on the writing surface over the reference image.

### DETAILED DESCRIPTION

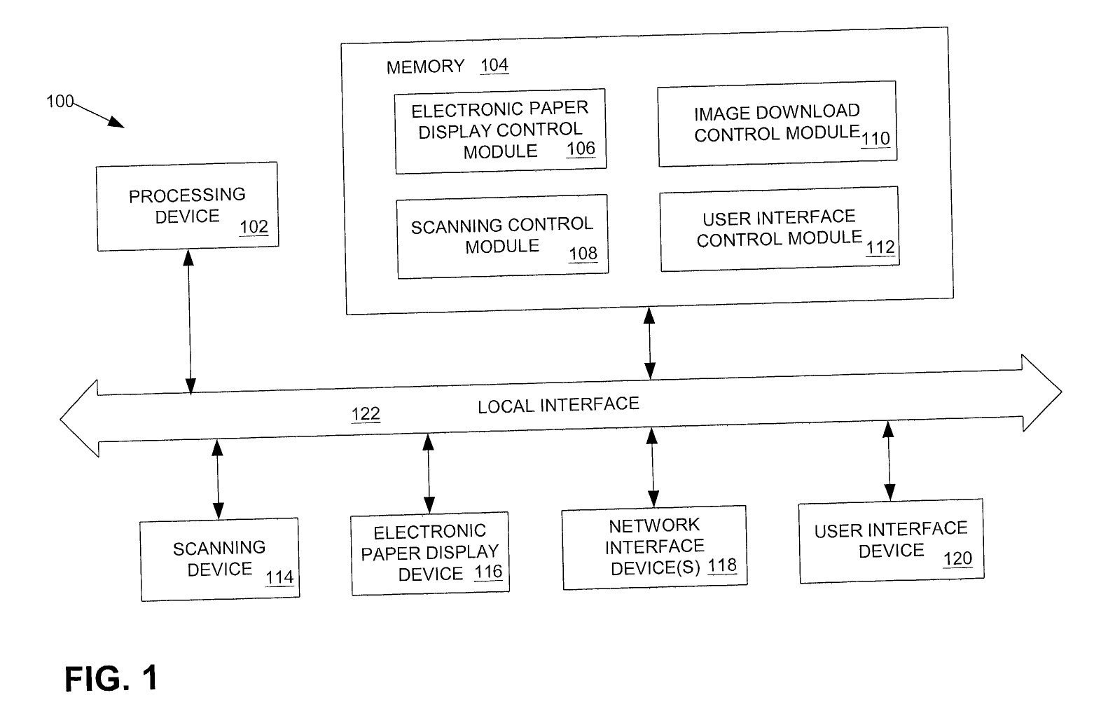

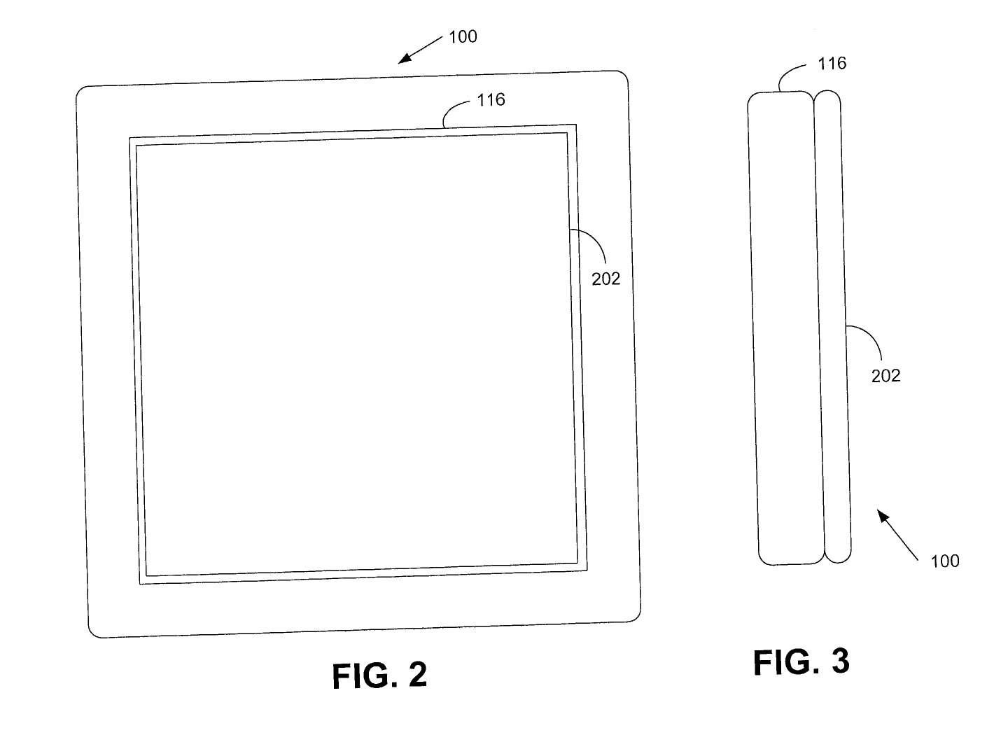

FIGS. 1 and 2 illustrate an embodiment of a whiteboard apparatus 100 according to the present invention. In general, whiteboard apparatus 100 provides a low-cost whiteboard, which enables a user to interact with a writing surface 202 arranged in a superimposed relationship with an electronic paper display device 116 configured to display electronic images. The user may select a particular electronic image to display on the electronic paper display device 116 and then mark over the electronic image on the writing surface 202. Thus, the whiteboard apparatus 100 enables a user to quickly, efficiently, and accurately display objects without having to manually mark on the writing surface 202.

In the embodiment illustrated in FIG. 3, whiteboard apparatus 100 comprises a processing device 102, memory 104, a scanning device 114, an electronic paper display device 116, a network interface device 118, and a user interface device 120 interconnected via a local interface 122. Memory 104 may comprise logic configured to implement functionality associated with the various devices connected to local interface 122. For example, as described in detail below, memory 104 may comprise an electronic paper display control module 106, a scanning control module 108, an image download control module 110, and a user interface control module 112.

Electronic paper display control module 106, scanning control module 108, image download control module 110, and user interface control module 112 may be implemented in hardware, software, firmware, or a combination thereof. As illustrated in FIG. 3, in one of a number of possible embodiments, electronic paper display control module 106, scanning control module 108, image download control module 110, and user interface control module 112 may be implemented in software or firmware that is stored in memory 104 and executed by processing device 102 or any other suitable instruction execution system. If implemented in hardware, as in alternative embodiments, electronic paper display control module 106, scanning control module 108, image download control module 110, and user interface control module 112 may be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Furthermore, although illustrated as separate components than devices 114, 116, 118, and 120, one of ordinary skill in the art will appreciate that the corresponding functionality embodied in modules 106, 108, 110, and 112 may be located in memory associated with the corresponding device, or in other memory connected via local interface 122. In addition, any descriptions of modules 108, 106, 110, and 112 should be understood as representing modules, segments, portions of code, or logical hardware which include the ability to produce executable instructions for implementing specific logical functions or steps. An alternate implementations are included within the scope of the preferred embodiment of the present invention, in which functions may be executed out of order from that shown or discussed, including substantially concurrently or in reverse order, depending on the functionality involved, as would be understood by those reasonably skilled in the art. Although illustrated as separate components, one of ordinary skill in the art will appreciate that modules 108, 106, 110, and 112 may be implemented as one or more modules that communicate with each other via local interface 122.

In addition, modules 106, 108, 110, and 112, which create or are comprised of executable instructions for implementing logical functions, may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Referring again to FIG. 3, the various components of whiteboard apparatus 100 will be described. Although each of these components are shown in the embodiment illustrated in FIG. 3, it will be appreciated that whiteboard apparatus 100 need not include all of these components. For example, as described below, scanning device 114 may be employed only in situations where it is desirable for whiteboard apparatus 100 to be configured to convert documents to electronic images to be stored and/or displayed on electronic paper display device 116. Furthermore, network interface device 118 may be employed only in situations where it is desirable for whiteboard apparatus 100 to be configured to communicate with a communications network.

Memory 104 may include any one or combination of volatile memory elements (e.g., random access memory (RAM, such as DRAM, SRAM, SDRAM, etc.)) and nonvolatile memory elements (e.g., ROM, hard drive, tape, CDROM, etc.). Memory 104 may incorporate electronic, magnetic, optical, and/or other types of storage media. Memory 104 may also have a distributed architecture, where various components are situated remote from one another, but may be accessed by the processing device 102. One of ordinary skill in the art will appreciate that whiteboard apparatus 100 may also comprise an operating system (not shown) and/or one or more applications (not shown).

In embodiments where an operating system is implemented, the operating system may be any of the following, or other, operating systems: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as PalmOS available from Palm Computing, Inc. and Windows CE available from Microsoft Corporation). The operating system essentially controls the execution of other computer programs, such as the applications and modules 106, 108, 110, and 112, and provides scheduling, input-output control, file and data management, memory management, and communication control and related services.

Local interface 122 may be, for example but not limited to, one or more buses or other wired or wireless connections. Local interface 122 may comprise additional elements, which are omitted for simplicity, such as controllers, buffers (caches), drivers, repeaters, and receivers, to enable communications. Further, local interface 122 may include address, control, and/or data connections to enable appropriate communications among processing device 102, memory 104, scanning device 114, electronic paper display device 116, network interface device 118, user interface device 120, and any other components included in whiteboard apparatus 100.

Processing device 102 may be a hardware device for executing software located in memory 104. Processing device 102 may be any custom made or commercially available processor, a central processing unit (CPU), a semiconductor based microprocessor (in the form of a microchip or chip set), a macroprocessor, or generally any device for executing software instructions.

Electronic paper display module 106 may comprise the logic configured to control electronic paper display device 116. In other words, electronic paper display module 106 may control the images to be displayed on electronic paper display device 116. Electronic paper display module 106 may receive the images to display on electronic paper display device 116 in a variety of ways. For example, electronic paper display module 106 may access the images to be displayed from memory 104. Electronic paper display module 106 may also access images received via scanning device 114, network interface device 118, or other input/output devices. Furthermore, as described below, electronic paper display module 106 may be configured to receive image selections from a user via user interface device 120. Thus, electronic paper display module 106 may be configured to cooperate with scanning control module 108, network control module 110, and user interface control module 113.

Electronic paper display device 116 may be any type of electronic paper display medium. For example, electronic paper display device 116 may comprise electronic paper, or so-called “e-paper.” Electronic paper is a low-cost, portable, and reusable storage and/or display medium that looks like paper, but can be repeatedly written on, or refreshed. Electronic paper is typically used for applications, such as electronic books, electronic newspapers, portable signs, and foldable and/or rollable displays.

Electronic paper display device 116 may comprise a large number of image elements contained within a thin sheet. One of ordinary skill in the art will appreciate that the resolution of electronic paper display device 116 increases as the number of image elements increases. Thus, in alternative embodiments, a smaller number of image elements may be implemented. Regardless of the number of image elements employed, each image element may comprise one or more charged particles. A portion of each charged particle may be one color and another portion may be another color. For instance, in a black-and-white display, the charged particles may have a black portion and a white portion. In order to display a particular image, an electrical charge may be applied to the charged particles such that the desired color is displayed. One of ordinary skill in the art will appreciate that the charged particles may be configured and oriented in a variety of ways to display black-and-white images, grey-scale images, and various scales of color images.

In certain embodiments, electronic paper display device 116 comprises SmartPaper®, which was developed by Xerox, Inc. at the Palo Alto Research Center (PARC) and currently manufactured and sold by Gyricon Media, Inc., headquartered in Palo Alto, Calif. (see http://www.gyriconmedia.com/). SmartPaper® is a reusable display material that has many of the properties of regular paper. For example, SmartPaper® is flexible, relatively inexpensive and is capable of storing images. SmartPaper® may be viewed in reflective light and also provides a wide-viewing angle. Unlike conventional paper, however, SmartPaper® is electrically writeable and erasable. SmartPaper® comprises a thin plastic sheet which contains millions of bichromal beads contained in tiny oil-filled cavities. Each sphere-like bead is contained in a separate cavity and has a positively-charged hemisphere of one color (black) and a negatively-charged hemisphere of another color (white). Images are displayed by controlling the orientation of the beads through an applied electrical charge to each bead. For example, a positive charge of a certain magnitude may be applied to one side of a cavity to display, on the other side, a positively-charged black hemisphere. Similarly, a negative charge of a certain magnitude may be applied to display a negatively-charged white hemisphere. The magnitude and sign (+/−) of the charge may be altered to partially orient the bead in order to display shades of grey. After a particular charge has been applied, the orientation of the bead may remain fixed until another charge is applied to change the orientation of the bead. Thus, SmartPaper® consumes very little power because a constant power is not required.

In other embodiments, electronic paper display device 116 may be a flexible electronic display device that implements the electronic ink technology developed by E Ink, Corp., of Cambridge, Mass. (see http://www.eink.com) and Lucent Technologies, headquartered in Murray Hill, N.J. Commercial implementations of this technology include E Ink's Ink-in-Motion® display and Radio Paper®. Electronic ink is a material that is processed into a film for integration into electronic displays. Electronic ink comprises a large number of tiny microcapsules, each about the diameter of a human hair. Each microcapsule contains positively-charged white particles and negatively-charged black particles suspended in a clear fluid. When a negative electric field is applied, the white particles move to the top of the microcapsule where they become visible to the user. This makes the surface appear white at that spot. At the same time, an opposite electric field pulls the black particles to the bottom of the microcapsules where they are hidden. By reversing this process, the black particles appear at the top of the capsule, which now makes the surface appear dark at that spot.

In an electronic ink display, the electronic ink is printed onto a sheet of plastic film that is laminated to a layer of circuitry. The circuitry forms a pattern of pixels that can then be controlled by a display driver. These microcapsules are suspended in a liquid “carrier medium” allowing them to be printed using existing screen printing processes onto virtually any surface, including glass, plastic, fabric and even paper. One of ordinary skill in the art will appreciate that electronic paper display device 116 may comprise any other display panel containing, for example, suspensions of electrophoretic display material, electrosensitive material, micromechanical apparatus, etc.

Scanning device 114 may be any device configured to convert a document, such as a paper document, into an electronic representation of the document. For example, scanning device 114 may be configured to optically capture text, illustrations, etc. printed on paper and translate the information into a computer-readable form. In other words, scanning device 114 digitizes the document by dividing it into a grid of boxes or pixels and representing each box with either a zero or a one, depending on whether the box is filled in. For color and gray scaling, the same principle applies, but each box is then represented by more than one bit. The resulting matrix of bits, referred to as a bit map, may then be stored in memory 104, manipulated by logic, and displayed on electronic paper display device 116.

One of ordinary skill in the art will appreciate that a number of scanning devices 114 may be employed in whiteboard apparatus 100. For example, a sheet-fed scanner may be implemented, in which mechanical rollers move the document to be scanned past a scan head. In other embodiments, a flatbead scanner may be implemented, in which the document to be scanned is stationary, for example, behind a glass window, while the scan head moves past the document. Scanning device 114 may also be a hand-held scanner in which the scan head is moved manually by a human hand across the document to be scanned. In further embodiments, whiteboard apparatus 100 may also employ a scanning device 114 for scanning the writing surface 202 and/or the image being displayed on electronic paper display device 116. For example, scanning device 114 may be configured with a scanning head that moves mechanically across the writing surface 202 or as a stationary scanner under which the electronic paper display device 116 and superimposed writing surface 202 is moved.

Scanning control module 108 may comprise logic configured to cooperate with scanning device 114 to convert the scanned document into an electronic representation of the document and/or store the electronic representation in memory 104. As is the case with electronic paper display module 106 and electronic paper display device 116, any logic associated with scanning control module 108 may also be integrated within scanning device 114. Furthermore, as described above, after the electronic representation of the document is generated, electronic paper display module 106 may access the electronic representation and display it on electronic paper display device 116 through the electronic paper display module 106.

As stated above, whiteboard apparatus 100 may be configured to receive images from a communications network via network interface device 118. Accordingly, network interface device(s) 118 may be any device configured to facilitate communication between whiteboard apparatus 100 and a communication network, such as a public or private packet-switched or other data network including the Internet, a circuit switched network, such as the public switched telephone network, a wireless network, an optical network, or any other desired communications infrastructure. Thus, image download control module 110 may comprise logic configured to control the communication process between whiteboard apparatus 100 and the communications network.

As stated above, whiteboard apparatus 100 enables a user to quickly, efficiently, and accurately display images and/or objects without having to manually mark on the writing surface 202. Accordingly, whiteboard apparatus 100 may further comprise a user interface device 120 configured to enable the user to select a particular image located in memory 104 to be displayed on electronic paper display device 116. User interface device 120 may comprise any device configured to enable a user to select a particular image to be displayed or to access any of a number of display images 111 stored in memory 104. For example, in one embodiment, user interface device(s) 120 may comprise hardware buttons corresponding to particular images to be displayed. In this manner, whiteboard apparatus 100 may be manufactured with predefined hardware buttons for various common images to be displayed on electronic paper display device 116. It will be appreciated that whiteboard apparatus 100 may be configured to enable a user to define which images are associated with the hardware buttons.

In alternative embodiments, user interface device(s) 120 may incorporate a graphical user interface to enable a user to view and select the images to be displayed. The graphical user interface may be as simple as a liquid crystal display (LCD) for displaying a list of the images and a navigation button, function key, etc. for scrolling through the list and selecting a particular image to be displayed. The graphical user interface may be more complex and may provide additional functionality. For example, the graphical user interface may be configured to enable the user to search for a particular image, edit an existing image located in memory 104, create a new image, etc. The graphical user interface may also incorporate other input/output devices, such as, a keyboard, a mouse, etc. to improve user interaction with whiteboard apparatus 100. User interface control module 112 may comprise the logic configured to control user interface devices 112 as described above.

One of ordinary skill in the art will appreciate that whiteboard apparatus 100 may further comprise other components not illustrated in FIG. 3. For example, whiteboard apparatus 100 may include any other input/output devices (not shown), such as, a serial port, a parallel port, a printer, speakers, etc.

As stated above and illustrated in FIGS. 1 and 2, whiteboard apparatus 100 comprises writing surface 202 arranged in a superimposed relationship with electronic paper display device 116. Writing surface 202 may comprise any material on which a user may place marks and through which the user may view an image displayed on electronic paper display device 116. For example, writing surface 202 may comprise a plastic cover on which a user may place and erase markings using a writing instrument, such as a dry-erase marker, and an eraser.

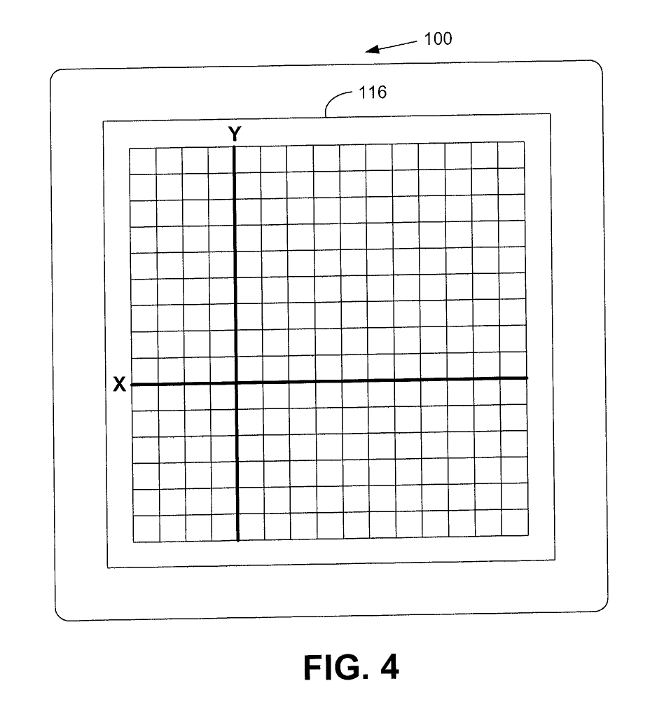

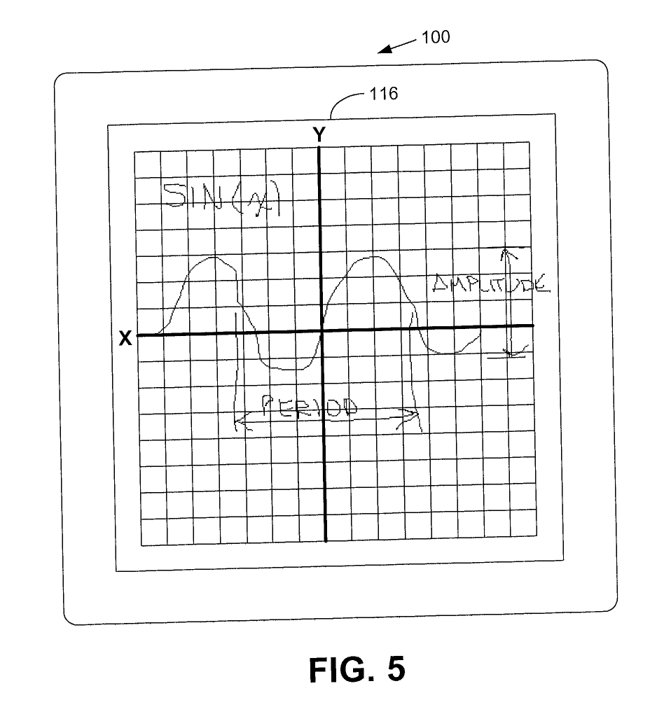

Referring to FIGS. 4-7, the operation of whiteboard apparatus 100 by one or more users, and various embodiments of representative images displayed on electronic paper display device 116, will be described. FIG. 4 is a front perspective view of the whiteboard apparatus 100 in which the electronic paper display device 116 is displaying a reference image, such as a Cartesian plane. For instance, one of the users may desire to draw a technical drawing, such as a sinusoidal wave, on writing surface 202. In order to assist the user in drawing the sinusoidal wave and improve the accuracy of the sinusoidal wave, it may be beneficial to first draw a reference image, such as a Cartesian plane, on the writing surface 202. Whiteboard apparatus 100 may be configured with the particular reference image in memory, thereby enabling the user to display the reference image on electronic paper display device 116 instead of drawing the reference image on writing surface 202. As described above, the user may also capture specific images via scanning device 114 and network interface device 118. As illustrated in FIG. 5, after the reference image is displayed on electronic paper display device 116, the user may more quickly, efficiently, and accurately draw the sinusoidal wave.

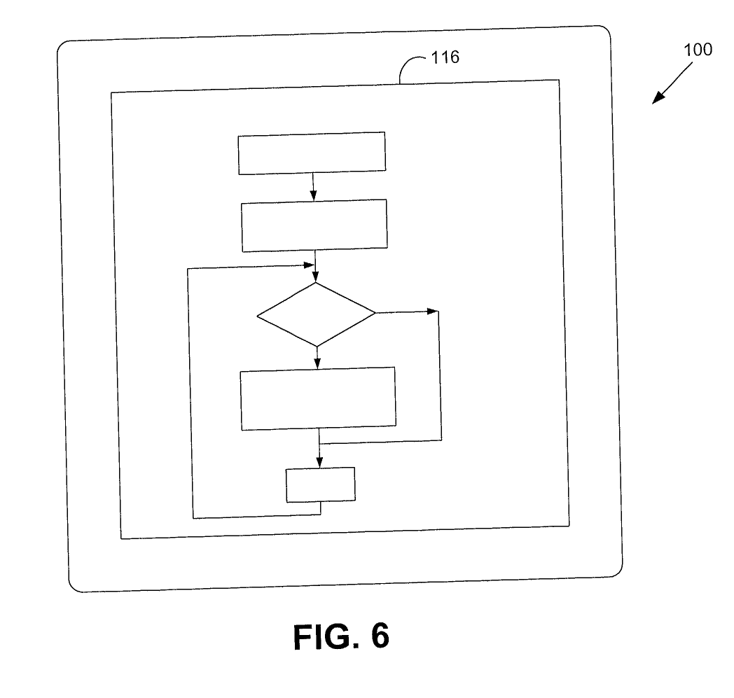

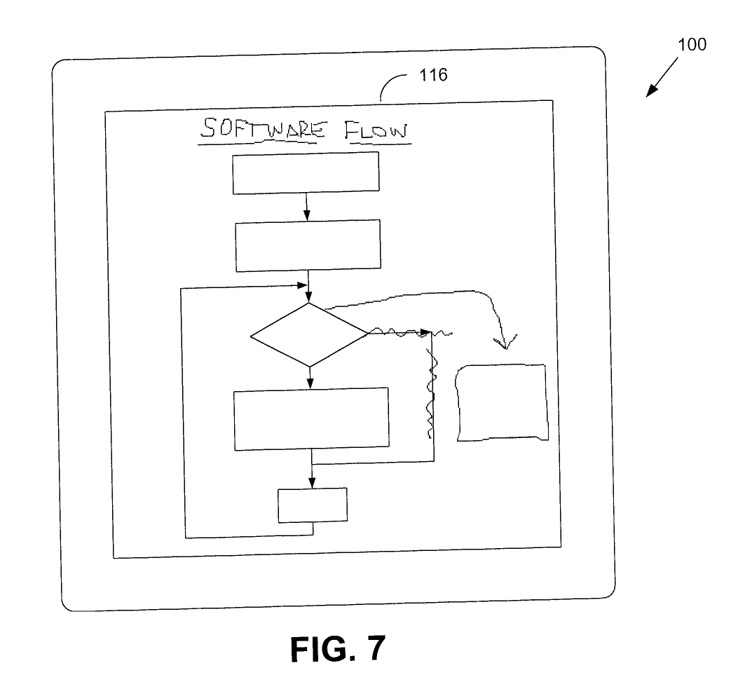

One of ordinary skill in the art will appreciate that whiteboard apparatus 100 may be configured to retrieve and/or display any type of image on electronic paper display device 116. As illustrated in FIGS. 6 and 7, the image displayed on electronic paper display device 116 may comprise a template of, for example, a process flow chart, over which a user may place text, objects, and/or other annotations. In the embodiment illustrated in FIG. 7, a user has written the title “Software Flow” on writing surface 202, as well as made other annotations. In alternative embodiments, whiteboard apparatus 100 may be configured to enable the user to display one or more objects, such as shapes, text, lines, other images, etc. on electronic paper display device 116 at different times during a session. For instance, instead of displaying the entire process flow chart illustrated in FIG. 6 as a single image, whiteboard apparatus 100 may be configured to enable the user to separately add each object comprising the flow chart and/or alter the location of each object after it has been displayed on the electronic paper display device 116.

It should be emphasized that the above-described embodiments of whiteboard apparatus 100, particularly, any “described” and/or “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and protected by the following claims.

Therefore, having thus described the invention, at least the following is claimed:

1. A whiteboard apparatus, comprising:
an electronic paper display device configured to display an image; and
a writing surface arranged in superimposed relationship with the electronic paper display device.

2. The whiteboard apparatus of claim 1, wherein the electronic paper display device comprises:
a plurality of image elements, each of the image elements having one or more charged particles; and
logic configured to display the image by controlling the orientation of the charged particles.

3. The whiteboard apparatus of claim 1, wherein the electronic paper display device employs electronic ink technology.

4. The whiteboard apparatus of claim 1, further comprising a network interface device configured for communication with a communication network and wherein the image displayed on the electronic paper display is received via the communication network.

5. The whiteboard apparatus of claim 1, wherein the electronic paper display device is further configured to display a reference image over which a user may write on the writing surface.

6. The whiteboard apparatus of claim 5, wherein the reference image comprises a Cartesian plane.

7. The whiteboard apparatus of claim 1, further comprising:
a memory configured to store one or more images to be displayed on the electronic paper display device.

8. The whiteboard apparatus of claim 7, further comprising a user interface device configured to enable a user to select one of the images stored in memory to be displayed on the electronic paper display device.

9. The whiteboard apparatus of claim 1, further comprising a scanning device configured to convert a document to an electronic image to be displayed on the electronic paper display device.

10. A method comprising the steps of:
providing an electronic paper display device configured to display an image on a whiteboard;
arranging a writing surface in superimposed relationship with the electronic paper display device; and
displaying an image on the electronic paper display device over which a user may write on the writing surface

11. The method of claim 10, further comprising the step of selecting the image to be displayed on the electronic paper display device.

12. The method of claim 10, further comprising the step of downloading the reference image to be displayed on the electronic paper display device.

13. The method of claim 10, wherein the electronic paper display device employs electronic ink technology.

14. The method of claim 10, wherein the image comprises a Cartesian plane.

15. The method of claim 10, further comprising the step of storing the image to be displayed on the electronic paper display device.

16. The method of claim 10, further comprising the step of scanning the image from a document.

17. The method of claim 10, further comprising the step of printing the image displayed on the electronic paper display device and the contents of the writing surface.

18. The method of claim 10, wherein the electronic paper display device comprises:
a plurality of image elements, each of the image elements having one or more charged particles; and
logic configured to display the image by controlling the orientation of the charged particles.
